(19) United States
(12) Patent Application Publication
(10) Pub. No.: US 2012/0064241 A1
(43) Pub. Date: Mar. 15, 2012

(54) METHOD OF SURFACE-TREATING ALUMINUM HEAT EXCHANGERS FOR VEHICLES, AND METHOD OF MANUFACTURING THE HEAT EXCHANGERS

(75) Inventors: Tatsuo YOSHIDA, Chiba (JP); Isao KAWASAKI, Osaka (JP); Takashi TERADA, Tochigi (JP); Satoshi MATSUMOTO, Tochigi (JP); Shintaro NAKAGAWA, Osaka (JP)

(73) Assignees: NIPPON PAINT CO., LTD., Osaka (JP); SHOWA DENKO K.K., Tokyo (JP)

(21) Appl. No.: 13/230,420

(22) Filed: Sep. 12, 2011

(30) Foreign Application Priority Data
Sep. 14, 2010 (JP) 2010-206144

(51) Int. Cl. B05D 3/02

(52) U.S. Cl. 427/226

(57) ABSTRACT

The present invention relates to a method of surface-treating an aluminum heat exchanger for vehicles in which a sufficient amount of photocatalytic metal oxide particles are retained on a surface of the heat exchanger in a state capable of exhibiting a photocatalytic activity thereof to remove VOC in a compartment of the vehicles by irradiating an ultraviolet ray thereto in an efficient manner. The method of surface-treating an aluminum heat exchanger for vehicles according to the present invention includes (1) a step of dispersing photocatalytic metal oxide particles whose surface is modified with apatite in an aqueous solution in which a low-temperature heat-decomposable resin is dissolved, to prepare a slurry; (2) a step of applying the slurry onto a surface of the heat exchanger; and (3) a step of drying the heat exchanger at a temperature of from 150 to 280° C. to decompose and remove a part of the low-temperature heat-decomposable resin on the surface of the photocatalytic metal oxide particles.

### FIELD OF THE INVENTION

The present invention relates to a method of surface-treating an aluminum heat exchanger for vehicles to allow photocatalytic metal oxide particles to adhere onto a surface of the heat exchanger, and a method of manufacturing the surface-treated heat exchanger.

### BACKGROUND OF THE INVENTION

In recent years, sick-house syndrome of houses owing to VOC (volatile organic compounds) has become problematic. In addition, in compartments of automobiles, there tends to occur the similar problem owing to VOC such as formaldehyde, acetaldehyde, toluene and xylene which are generated from materials or adhesives used therein. Therefore, various methods for removing VOC in the automobile compartments have been put into practice or attempted.

For example, various materials, fabricating methods and adhesives for interior parts of automobiles have been reexamined or restudied to suppress and reduce an amount of VOC generated therefrom. However, these methods have failed to completely eliminate the VOC generated.

In addition, it has been attempted to install a filter capable of adsorbing the VOC within a duct of an air conditioner. However, the filter must be periodically replaced with new one.

On the other hand, there has been proposed and attempted a method of removing VOC by irradiating an ultraviolet ray to a surface of a heat exchanger which is coated with a water dispersion of photocatalytic metal oxide particles, using a UV lamp. In the method, bothersome maintenance procedures such as replacement of the filter is not necessary. However, the method in which the water dispersion of photocatalytic metal oxide fine particles is applied onto the surface of the heat exchanger tends to still have the following problem. For example, ever though a water dispersion of the photocatalytic metal oxide particles is applied as such onto the surface of the heat exchanger, it may be difficult to fix the photocatalytic metal oxide particles onto the surface of the heat exchanger to a sufficient extent. When operating the air conditioner under such a condition, the photocatalytic metal oxide particles tend to be removed from the surface of the heat exchanger owing to air passing thereover and scattered in the compartment, or tend to be flowed off from the surface of the heat exchanger by condensed water. Further, even when the surface of the heat exchanger is treated with such a water dispersion having a low viscosity, the water dispersion tends to be flowed off during a drying step, thereby failing to retain a sufficient amount of the photocatalytic metal oxide particles thereon.

On the other hand, in the case where a dispersion prepared by dispersing the photocatalytic metal oxide particles in an aqueous solution of an inorganic resin as a binder is used for the surface treatment, there tends to occur the problem of generation of malodor owing to the inorganic resin.

When a dispersion prepared by dispersing the photocatalytic metal oxide particles in an aqueous solution of an organic resin as a binder which is substantially free from generation of odor is used in the surface treatment, not only VOC but also the organic resin tend to be decomposed upon irradiating an ultraviolet ray to the photocatalyst, so that the photocatalytic metal oxide particles tend to be dropped off from the surface of the heat exchanger. In addition, if the photocatalytic metal oxide particles are coated with an excessive amount of the resin, the photocatalytic metal oxide particles fail to sufficiently exhibit their photocatalytic effect on the VOC.

Further, it is also known that a photocatalytic apatite formed by incorporating a metal oxide having a photocatalytic activity and a metal ion having an antibacterial property (such as a silver ion and a copper ion) into an apatite crystal structure exhibits an excellent decomposability and an excellent adsorptivity to various organic substances such as VOC and specific adsorbates such as viruses (Patent Document 1).

Patent Document 1: JP 2007-260587A

### SUMMARY OF THE INVENTION

An object of the present invention is to provide a method of surface-treating an aluminum heat exchanger for vehicles on a surface of which a sufficient amount of photocatalytic metal oxide particles are retained or supported in the state capable of exhibiting a photocatalytic activity to remove VOC in a compartment of the vehicles by irradiation with an ultraviolet ray in an efficient manner, as well as a method of manufacturing such a heat exchanger.

As a result of intense and extensive researches, the present inventors have found that the above conventional problems can be solved by the method of coating a surface of a heat exchanger with a resin dispersion of photocatalytic metal oxide particles, wherein apatite-modified photocatalytic metal oxide particles are adhered onto the surface of the heat exchanger by using a low-temperature heat-decomposable resin as a binder, and the thus surface-treated heat exchanger is subjected to a drying treatment to decompose a part of the low-temperature heat-decomposable resin and thereby expose the active photocatalytic metal oxide particles on the surface of the heat exchanger. The present invention has been accomplished on the basis of the above finding.

Thus, the present invention relates to the following aspects:

[1] A method of surface-treating an aluminum heat exchanger for vehicles including:

(1) a step of dispersing photocatalytic metal oxide particles whose surface is modified with apatite in an aqueous solution in which a low-temperature heat-decomposable resin is dissolved, to prepare a slurry;

(2) a step of applying the slurry onto a surface of the heat exchanger; and

(3) a step of drying the heat exchanger at a temperature of from 150 to 280° C. to decompose and remove a part of the low-temperature heat-decomposable resin on the surface of the photocatalytic metal oxide particles.

[2] A method of manufacturing an aluminum heat exchanger for vehicles, including the steps of:

producing a heat exchanger through assembling and brazing steps; and

subjecting the heat exchanger to surface treatment by the method as defined in the above [1].

[3] A method of manufacturing an aluminum heat exchanger for vehicles, including the steps of:

producing a heat exchanger through assembling and brazing steps;

subjecting the heat exchanger to acid-washing treatment and chemical conversion treatment; and

subjecting the heat exchanger to surface treatment by the method as defined in the above [1].

[4] A method of manufacturing an aluminum heat exchanger for vehicles, including the steps of:

producing a heat exchanger through assembling and brazing steps;

subjecting the heat exchanger to acid-washing treatment and chemical conversion treatment;

subjecting the heat exchanger to hydrophilic treatment to form irregularities on a surface of the heat exchanger; and

subjecting the heat exchanger to surface treatment by the method as defined in the above [1].

### EFFECT OF THE INVENTION

In the aluminum heat exchanger for vehicles which is surface-treated according to the present invention, a sufficient amount of the apatite-modified. photocatalytic metal oxide particles are firmly adhered onto a surface of the heat exchanger by using the low-temperature heat-decomposable resin as a binder. Therefore, the photocatalytic metal oxide particles adhered. onto the surface of the heat exchanger are free from scattering by air passing thereover upon operating an air conditioner and from flowing-off by condensed water, Further, the photocatalytic metal oxide particles are allowed to expose on the surface of the heat exchanger, so that an excellent effect of removing VOC by irradiation with an ultraviolet ray can be exhibited.

In addition, the heat exchanger is preferably subjected to hydrophilic treatment during a manufacturing process thereof, whereby adhesion of the photocatalytic metal oxide particles to the surface of the heat exchanger can be further enhanced.

Further, when the photocatalytic metal oxide particles adhered onto the surface of the neat exchanger are irradiated with an ultraviolet ray, it is expected to attain various functions required for heat exchangers, in particular, for an evaporator, such as a hydrophilicity, an antibacterial property, a mildew-proof property and an anti-fouling property.

### DETAILED DESCRIPTION OF THE INVENTION

The present invention relates to a method of surface-treating an aluminum heat exchanger for vehicles, wherein photocatalytic metal oxide particles are adhered onto a surface of the heat exchanger by using a low-temperature heat-decomposable resin as a binder, and the thus surface-treated heat exchanger is subjected to a drying treatment to decompose a part of the low-temperature heat-decomposable resin and thereby expose the active photocatalytic metal oxide particles on the surface of the heat exchanger.

In the first step of the surface-treating method according to the present invention, the photocatalytic metal oxide particles whose surface is modified. with apatite are dispersed in an aqueous solution in which a low-temperature heat-decomposable resin is dissolved, to prepare a slurry.

Examples of the preferred photocatalytic metal oxide particles used in the present invention include particles of titanium oxide. As the titanium oxide, an anatase-type titanium oxide is preferably used rather than a rutile-type titanium oxide in order to more effectively exhibit a photocatalytic performance. In addition, in order to prevent decomposition of the low-temperature heat-decomposable resin as a binder after adhering onto the surface of the heat exchanger, it is required that the surface of the respective photocatalytic metal oxide particles is modified with apatite (calcium phosphate). The primary particles of the apatite-modified titanium oxide preferably have an average particle size of from 10 to 500 nm. Meanwhile, the average particle size of the apatite-modified titanium oxide primary particles may be determined from an arithmetic mean value of primary particle sizes measured by observation using an electron microscope.

Examples of the apatite-modified titanium oxide include “Jupiter F4-APS” available from Showa Titanium Co., Ltd., (anatase-type titanium oxide particles having an average particle size of 30 nm which are respectively coated with an apatite layer having a thickness of several Å (coating amount per titanium oxide: about 1%).

The low-temperature heat-decomposable resin used in the present invention is an organic resin capable of being thermally decomposed at a temperature of from 150 to 280° C. Examples of the low-temperature heat-decomposable resin include modified polyether-based resins such as polyethyleneoxide “POLYOX™ WSR N-750” available from Dow Chemical Co., and “MELPOL™ F-220” available from Sanyo Chemical Industries, Ltd.

In the present invention, the slurry in which the photocatalytic metal oxide particles whose surface is modified with apatite are dispersed in the aqueous solution in which the low-temperature heat-decomposable resin is dissolved may be obtained by dispersing the photocatalytic metal oxide particles in the aqueous solution of the low-temperature heat-decomposable resin having a solid content of from 0.1 to 10% by mass such that a concentration of the photocatalytic metal oxide particles in the slurry is from 1 to 30% by mass. When the solid content of the low-temperature heat-decomposable resin in the aqueous solution exceeds 10% by mass or when the concentration of the photocatalytic metal oxide particles in the slurry exceeds 30% by mass, the resulting slurry tends to exhibit an excessively high viscosity, so that it may be difficult to coat the surface of the heat exchanger with the slurry. When the solid content of the low-temperature heat-decomposable resin in the aqueous solution is less than 0.1% by mass or when the concentration of the photocatalytic metal oxide particles in the slurry is less than 1% by mass, the resulting slurry tends to exhibit an excessively low viscosity and therefore hardly applied in a sufficient amount onto the surface of the heat exchanger.

The slurry used in the present invention may also contain a surfactant, a defoaming agent, an antibacterial agent or a mildew-proof agent.

In the second step of the surface-treating method according to the present invention, the above prepared slurry is applied onto the surface of the heat exchanger.

The slurry in which the photocatalytic metal oxide particles are dispersed may be applied onto the surface of the heat exchanger by a dipping method or a spraying method. Thereafter, a surplus amount of the slurry applied is removed by centrifugal separation from the surface of the heat exchanger. The amount of the slurry to be retained on the surface of the heat exchanger may be adjusted by suitably controlling a rotating speed or a rotating time in the centrifugal separation procedure. The coating amount of the slurry is preferably in the range of not less than 0.05 g/m² and not more than 5 g/m², more preferably not less than 0.1 g/m² and not more than 2 g/m² in terms of an amount of the photocatalytic metal oxide particles whose surface is modified with apatite.

In the third step of the surface-treating method according to the present invention, the heat exchanger whose surface is coated with the slurry is subjected to drying treatment at a temperature of from 150 to 280° C. to decompose and remove a part of the low-temperature heat-decomposable resin on the surface of the respective photocatalytic metal oxide particles, and thereby allow the photocatalytic metal oxide particles to be exposed.

After applying the slurry, the surface of the heat exchanger is dried using a hot air circulation-type drying furnace, etc. The drying temperature is not lower than 150° C. and not higher than 280° C. When the drying temperature is lower than 150° C., it may be difficult to dry and solidify the slurry to a sufficient extent, so that the coating film of the slurry tends to be dissolved in condensed water upon operating an air conditioner. When the drying temperature is higher than 280° C., the low-temperature heat-decomposable resin tends to be decomposed excessively, so that adhesion of the photocatalytic metal oxide particles onto the surface of the heat exchanger tends to be deteriorated. The lower limit of the drying temperature is preferably 160° C. and more preferably 170° C., whereas the upper limit of the drying temperature is preferably 240° C. and more preferably 220° C., The drying time is not shorter than 15 min and not longer than 60 min, and more preferably not shorter than 30 min and not longer than 45 min.

The present invention also relates to a method of manufacturing an aluminum heat exchanger for vehicles which includes the step of subjecting the heat exchanger produced through assembling and brazing steps to the above surface-treating method.

The heat exchanger for vehicles as used herein means an evaporator or a heater core as a heat exchanger portion of an air conditioner for cars.

In the case where the heat exchanger is the evaporator, respective necessary parts are assembled and brazed to produce a heat exchanger, and the thus formed heat exchanger is washed with an acid., and subjected to chemical conversion treatment (chromate or non-chromate treatment) and then to hydrophilic treatment to form irregularities on the surface of the heat exchanger, and further subjected to the above surface-treating method. The manufacturing method including these steps is preferred from the viewpoint of enhancing adhesion of the photocatalytic metal oxide particles onto the surface of the heat exchanger.

The hydrophilic treatment for forming irregularities on the surface of the heat exchanger may be carried out by surface-treating the heat exchanger with a water-soluble resin solution containing particles, for example, “SURFALCOAT™ 1100” available from Nippon Paint Co., Ltd.

In the case where the heat exchanger is the heater core, the heat exchanger produced through assembling and brazing steps may be directly subjected to the above surface-treating method without any pre-treatments, or may be first subjected to add-washing treatment and chemical conversion treatment (chromate or non-chromate treatment) and then to the above surface-treat mg method.

The heat exchanger (evaporator and/or heater core) onto which the photocatalytic metal oxide particles are adhered by the above surface-treating method is irradiated with an ultraviolet ray from a UV lamp installed in the vicinity of the heat exchanger to thereby enable removal of VOC.

### EXAMPLES

The present invention is described in more detail below by referring to the following Examples. However, these Examples are only illustrative and not intended to limit the invention thereto.

### Examples 1 to 4 And Comparative Examples 1 to 4

Under the conditions shown in Table 1, an organic resin coating layer of photocatalytic metal oxide particles which were partially exposed to outside was formed on a surface of a test piece [aluminum plate “A1100P” (7×15×0.08 cm) available from Nippon Testpanel Co., Ltd.] and a cut part of a heat exchanger [cut part of an evaporator (7×4×3 cm) available from Showa Denko K. K.]. The former test piece was evaluated for an adhesion property of the particles, whereas the latter cut part was evaluated for removal of VOC.

The conditions used in the pretreatments of the test piece and the cut part of the heat exchanger, the treatment with a dispersion of the photocatalytic metal oxide particles and the drying treatment as well as the test methods for evaluating the adhesion property and the removal of VOC are shown below.

<Pretreatments of Test Piece and Cut Part of Heat Exchanger>

The pretreatments were carried out in the following order.

Degreasing (test piece only): Dipped in a 3% by mass aqueous solution of “SURFCLEANER™ 322N-8” available from Nippon Paint Co., Ltd., at 70° C. for 30 sec.

Water-washing after degreasing (test piece only): Sprayed with a tap water for 10 sec.

Acid-washing: Dipped in a mixed aqueous solution containing 5% by mass of sulfuric acid and 4% by mass of nitric acid at 70° C. for 160 sec.

Water-washing after acid-washing: Sprayed with a tap water for 30 sec.

Chemical conversion treatment: Dipped in a 10% by mass aqueous solution of “ALSURF™ 90” available from Nippon Paint Co., Ltd., whose pH was adjusted to 4.0, at 60° C. for 60 sec.

Water-washing after chemical conversion treatment: Sprayed with a tap water for 30 sec.

Hydrophilic treatment: Dipped in a 25% by mass aqueous solution of “SURFALCOAT™ 1100” available from Nippon Paint Co,, Ltd., at 25° C. for 10 SEC.

Drying treatment: The test piece or cut part which was washed with water after the chemical conversion treatment or subjected to the hydrophilic treatment was dried at 170° C. for 30 min.

<Treatment with Dispersion of Photocatalytic Metal Oxide>

The test piece or the cut part of the heat exchanger after being subjected to the above pretreatments was dipped in an aqueous dispersion of photocatalytic metal oxide containing the following photocatalytic metal oxide and organic resin in amounts shown in Table 1, at 25° C. for 10 sec. (Photocatalytic Metal Oxide):

“Jupiter F4-APS” available from Showa Titanium Co., Ltd., (anatase-type titanium oxide particles surface-modified with apatite; average particle size of primary particles thereof 30 nm)

(Organic Resin):

(a) Polyethyleneoxide “POLYOX™ WSR N-750” available from Dow Chemical Co.; (molecular weight: 300,000) (polyethyleneoxide-based resin; low-temperature heat-decomposable resin)

(b) “MELPOL™ F-220” available from Sanyo Chemical Industries, Ltd.; (polyether-based resin; low-temperature heat-decomposable resin)

(c) “KURARAY POVAL PVA-105” available from Kuraray Co., Ltd.; (polyvinyl alcohol-based resin)

<Drying Treatment>

The test piece or the cut part of the heat exchanger after being treated with the above dispersion of the photocatalytic metal oxide was subjected to drying treatment in a hot air circulation-type drying furnace under the conditions shown in Table 1.

<Evaluation Test Methods>

(1) Evaluation for Adhesion Property

The test piece was rubbed with fingers and visually observed to examine an extent of peel-off of the photocatalytic metal oxide layer. The results were evaluated according to the following ratings.

A: No peel-off of the layer was recognized.

B: Slight peel-off of the layer was recognized.

C: Considerable peel-off of the layer was recognized,

(2) Evaluation for Removal of VOC

The respective treated cut parts of the heat exchanger were placed in a 1 L chamber. The chamber was filled with air containing acetaldehyde as VOC (initial concentration: 2000 ppm; relative humidity: 50% (at 25° C.)). The chamber was placed in a dark place for 2 h, and thereafter an ultraviolet ray was irradiated thereto from a black light as a light source under the condition of 1 mW/cm² for 7 h. The air in the chamber was sampled before irradiation with UV (after adsorbed) and after the irradiation with UV to measure a concentration of acetaldehyde therein by gas chromatography. The rate (%) of removal of VOC was calculated from the following formula.

[(Concentration after adsorbed)−(Concentration after irradiated)]/(Concentration after adsorbed)×100

The results of the evaluation for adhesion property and the evaluation for removal of VOC are shown in Table 1.

TABLE 1

| | | Dispersion of modified | | | | | | Removal of VOC (concentration of | | |
|---|---|---|---|---|---|---|---|---|---|---|
| | | titanium oxide | | | | | | acetaldehyde) | | |
| | | | | Amount | | | | Conc. | Conc. after | |
| | | | Amount | of | Drying conditions | | Adhesion | after | irradiated | Rate of |
| | | Kind of | of resin | titanium | Temp. | Time | property | adsorbed | with light | removal |
| No. | Treatments | resin | (mass %) | (mass %) | (° C.) | (min) | Rubbing | (ppm) | (ppm) | (%) |
| Example 1 | Up to chemical | (a) | 0.3 | 2.7 | 170 | 15 | B | 800 | 100 | 88 |
| | conversion | | | | | | | | | |
| | treatment | | | | | | | | | |
| Example 2 | Up to hydrophilic | (a) | 0.3 | 2.7 | 170 | 15 | A | 800 | 100 | 88 |
| | treatment | | | | | | | | | |
| Example 3 | Up to hydrophilic | (a) | 0.3 | 2.7 | 220 | 15 | A | 700 | 50 | 93 |
| | treatment | | | | | | | | | |
| Example 4 | Up to hydrophilic | (b) | 0.3 | 2.7 | 170 | 15 | A | 900 | 100 | 89 |
| | treatment | | | | | | | | | |
| Comparative | Up to hydrophilic | (a) | 0.3 | 2.7 | 300 | 15 | C | 700 | 50 | 93 |
| Example 1 | treatment | | | | | | | | | |
| Comparative | Up to hydrophilic | (c) | 0.3 | 2.7 | 170 | −15 | A | 800 | 800 | 0 |
| Example 2 | treatment | | | | | | | | | |
| Comparative | Up to hydrophilic | — | 0 | 2.7 | 170 | 15 | C | 700 | 50 | 93 |
| Example 3 | treatment | | | | | | | | | |
| Comparative | Up to hydrophilic | — | — | — | — | — | — | 1000 | 900 | 10 |
| Example 4 | treatment | | | | | | | | | |

In Examples 2, 3 and 4 in which after the pretreatments up to the hydrophilic treatment were conducted, the layer of the photocatalytic metal oxide particles coated with the low-temperature heat-decomposable resin was formed on the surface of the test piece or cut part such that a part of the photocatalytic metal oxide was exposed, it was confirmed that the photocatalytic metal oxide layer was excellent in both of adhesion property and removal of VOC.

In Comparative Example 1 in which the drying treatment was conducted at 300° C., it was confirmed that the low-temperature heat-decomposable resin was excessively decomposed, so that the photocatalytic metal oxide layer was deteriorated in adhesion property.

In Comparative Example 2 in which the organic resin (polyvinyl alcohol-based resin) incapable of being decomposed at 170° C. was used, it was confirmed that the photocatalytic metal oxide particles were still entirely coated with the organic resin, so that the removal of VOC was not caused at all.

In Comparative Example 3 in which the dispersion of the photocatalytic metal oxide containing no organic resin was used, it was not possible to retain the photocatalytic metal oxide particles on the surface of the test piece, etc.

In Comparative Example 4 in which no treatment with the dispersion of the photocatalytic metal oxide was conducted, it was confirmed that almost no removal of VOC was conducted.

1. A method of surface-treating an aluminum heat exchanger for vehicles comprising:
(1) a step of dispersing photocatalytic metal oxide particles whose surface is modified with apatite in an aqueous solution in which a low-temperature heat-decomposable resin is dissolved, to prepare a slurry;
(2) a step of applying the slurry onto a surface of the heat exchanger; and
(3) a step of drying the heat exchanger at a temperature of from 150 to 280° C. to decompose and remove a part of the low-temperature heat-decomposable resin on the surface of the photocatalytic metal oxide particles.

2. A method of manufacturing an aluminum heat exchanger for vehicles, comprising the steps of:
producing a heat exchanger through assembling and brazing steps; and
subjecting the heat exchanger to surface treatment by the method as defined in claim 1.

3. A method of manufacturing an aluminum heat exchanger for vehicles, comprising the steps of:
producing a heat exchanger through assembling and brazing steps;
subjecting the heat exchanger to acid-washing treatment and chemical conversion treatment; and
subjecting the heat exchanger to surface treatment by the method as defined in claim 1.

4. A method of manufacturing an aluminum heat exchanger for vehicles, comprising the steps of:
producing a heat exchanger through assembling and brazing steps;
subjecting the heat exchanger to acid-washing treatment and chemical conversion treatment;
subjecting the heat exchanger to hydrophilic treatment to form irregularities on a surface of the heat exchanger; and
subjecting the heat exchanger to surface treatment by the method as defined in claim 1.
